(19) United States
(12) Patent Application Publication
(10) Pub. No.: US 2005/0008837 A1
(43) Pub. Date: Jan. 13, 2005

(54) Tri-color extruded warning sign and method of fabricating same

(76) Inventor: Albert A. Burlando, Flanders, NJ (US)

Correspondence Address: PITNEY HARDIN LLP, 7 TIMES SQUARE, NEW YORK, NY, 10036-7311, US

(21) Appl. No.: 10/752,451

(22) Filed: Jan. 6, 2004

Related U.S. Application Data
(60) Provisional application No. 60/437,916, filed on Jan. 6, 2003.

(51) Int. Cl. B32B 7/02

(52) U.S. Cl. 428/212

(57) ABSTRACT

A sign and method of manufacturing same to impart information or warning to an individual, the sign having three distinct levels, each level of a separate color, the selective removal of a portion of one level revealing the color of the second level and the continued removal of the second level revealing the color of the third level, thereby forming a sign with a three dimensional message, the third or lower most level preferably being of a color translucent to light so as to enhance visibility or warning when backlit by natural or artificial light, the middle layer preferably being black in order to impart a text message, and the first layer or upper layer being of a high visibility color, preferably white.

### RELATED INVENTIONS

Applicant claims the benefit of provisional application Ser. No. 60/437,916, filed Jan. 6, 2003.

### BACKGROUND OF THE INVENTION

1. Field of the Invention

The present invention relates to signs of all types, but in particular, to warning signs which are mandated by government rule, regulation or industry standard and are required to meet certain ANSI standards, the signs of the type disclosed herein exhibit a superior visibility, are capable of being back lighted, and offer significantly longer life span due to the materials used and the method of manufacture.

2. Description of the Prior Art

Government rules and regulations relating to industry and industrial specifications themselves specify signage requirements in many specifically identified facilities or work places. These warning signs are mandated by various government agencies, such as ANSI, OSHA and EPA or the specific industry themselves and the regulations most often specify the colors to be used on the sign and the information to be placed on the sign. For example, in the electrical power industry, such warning signs are required on the fence or enclosure surrounding a high voltage facility or equipment, and in many instances on the equipment itself. Still further in the same electrical power industry, warning signs are often times required on utility poles to warn individuals of the capacity being transmitted through the overhead wires.

In the past these signs were fabricated out of metal and were painted with the appropriate colors meeting the ANSI standards and then posted on the aforesaid places. However, this type of sign did not respond well to an inclement environment and inclement weather. The colors would begin to fade, the signs would begin to rust, and over time they were ineffective of accomplishing the purpose for which they were intended.

Applicant has developed a tri-color extruded sign and method of making same, the colors of which do not fade over time, since pigment is not being painted on, but permeates each of the selected extruded levels forming the sign. While Applicant has developed a tri-color extruded sign in order to permit individuals or industry to comply with government signage regulations in areas where there is danger, or the necessity to warn people or to provide notice to people, the sign can have application to many other uses without departing from the spirit and scope of the invention.

### OBJECTS OF THE INVENTION

An object of the present invention is to provide for a novel tri-color, 3 level, 3 dimension sign for providing warnings, information or messages by selectively removing a portion of one or two levels to form the three dimensional message.

Another object of the present invention is to provide for a novel informational sign in which the color of the third level is translucent to light, thereby enhancing the visibility and three dimensional aspects of the sign.

A still further object of the present invention is to provide for a novel informational sign which will not crack, fade, chip or peel.

A still further object of the present invention is to provide for a novel informational sign which is impact resistant at freezing temperatures.

A still further object of the present invention is to provide for a novel informational sign which is nonconductive and noncorrosive.

A still further object of the present invention is to provide for a novel informational sign which is readable even if over-painted.

A still further object of the present invention is to provide for a novel informational sign in which the three distinct color levels are bonded and not separable after fabrication.

Another object of the present invention is to provide for a novel method of manufacturing a sign material comprised of three distinct color levels and that when cut to the desired size can impart information or a message by selectively removing a portion of one or two of the color levels to form a three dimensional message.

### SUMMARY OF THE INVENTION

A sign and method of manufacturing same to impart information or warning to an individual, the sign having three distinct levels, each level of a separate color, the selective removal of a portion of one level revealing the color of the second level and the continued removal of the second level revealing the color of the third level, thereby forming a sign with a three dimensional message, the third or lower most level preferably being of a color translucent to light so as to enhance visibility or warning when backlit by natural or artificial light, the middle layer preferably being black in order to impart a text message, and the first layer or upper layer being of a high visibility color, preferably white.

### DETAILED DESCRIPTION OF THE DRAWINGS

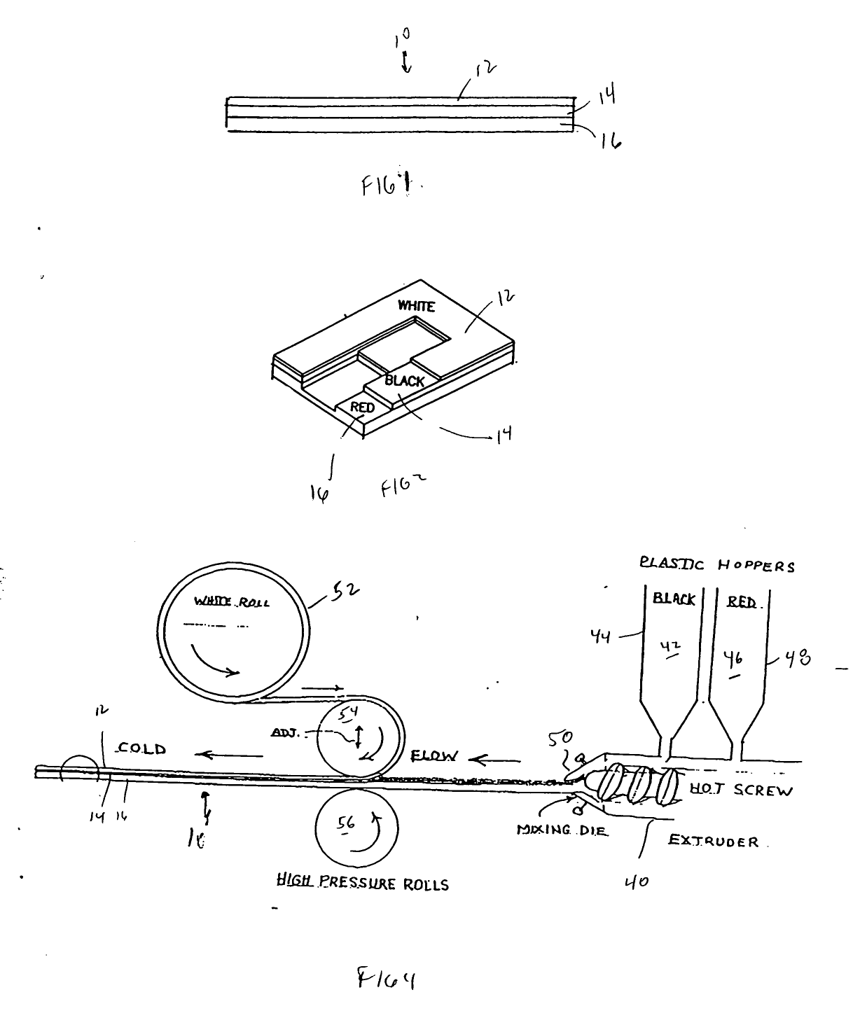

FIG. 1 is a side view of the sign illustrating its three level characteristics;

FIG. 2 is a perspective partial cutaway view of the sign material illustrating its three level characteristics;

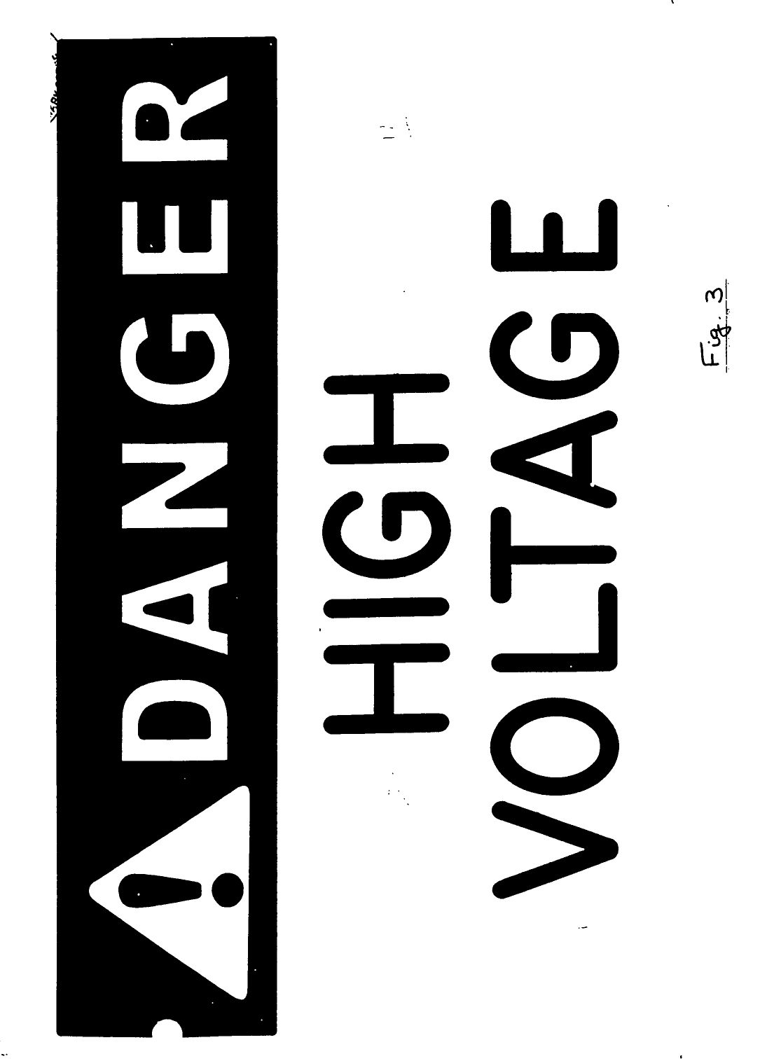

FIG. 3 is a front view of a typical sign used in the electric power industry fabricated in accordance with the teachings hereof; and

FIG. 4 is a schematic of the method and manufacture of the three level sign material, which after being cut to appropriate size, and abraded to the appropriate depth, results in the sign as illustrated in FIG. 3.

### DETAILED DESCRIPTION OF THE INVENTION

FIG. 1 is a side view of a sign material 10 fabricated in accordance with the teachings of this disclosure. FIG. 2 is a perspective partial cutaway view of the sign material after fabrication. The sign material 10 is extruded as described hereafter and comprises three levels. Each level is formed of high density polyethylene which is UV stabilized. The upper level 12 which would be pigmented white would have a thickness after extrusion preferably of 0.020 inches. The second level 14, preferably black, for contrast with the white level for forming text messaging, would preferably be a thickness of 0.035 inches. The third level 16 illustrated with respect to this particular sign material 10 would be red and its thickness would vary depending upon the size of the sign being fabricated. For signs in the ranges up to 10 inches by 14 inches, the third level 16 thickness of red would be 0.070 inches. For larger signs, the thickness of the third level 16 would increase in order to provide stability to the sign. The sign material 10 is of one piece construction having the particular pigment permeated throughout each selective level. As such, the sign material 10 cannot delaminate.

FIG. 3 illustrates a front view of a sign 18 fabricated for the high power electrical industry. It is essentially a warning sign warning “Danger, High Voltage”. Sign 18 would be placed on the fence surrounding a generator or power station or transformer and might also be placed on the piece of equipment itself. With respect to FIG. 3, the sign material 10 has been fabricated and cut to the standardized size for sign 10. Selective areas of levels 1 and levels 2 of the sign 18 are then abraded or removed by routing, engraving, abrading or other suitable method to form the message on the sign. In the sign 18 illustrated in FIG. 3, the upper or white level 12 has been abraded or routed 20 to reveal selective portions of the second level so as to impart the message, “High Voltage”. In another selected area, the level one white level 12 and the level 2 black level 14 have been abraded or routed 22 to reveal the third level, the red level 16. The red level 16 stands as a background for the heading 24 contained therein, namely the triangle with exclamation point and the word “Danger”, both of which are comprised of all three levels of the sign material. The red level 16, being the back level, is translucent to natural or artificial light. It will therefore provide greater visibility and warning to people approaching the fence or the equipment in that it will impart a glow to that portion of the sign which would be particularly advantageous in the evening.

The backlighting feature of a sign manufactured and fabricated in accordance with the teachings herein, would also have significant use indoors for displays, exit signs, window signs or door signs. The third level 16 could be composed of any implemented plastic that would be translucent to artificial or natural light and could very well be used for directional signs in hallways within buildings.

The relatively thin thickness of the first level 12 pigmented white allows for the manufacturer to impart a text message in black letters, second level 1, 16, without having to remove a great excessive of material from the first level 12 pigmented white.

The sign 18 illustrated in FIG. 3 illustrates a third level 16 pigmented red. The third level pigmentation can be changed depending upon the desired message to be imparted by the sign. For instance the pigment or color yellow is normally associated with a caution sign. Therefore the sign of the present invention could be fabricated with a first level of white pigmentation, a second level of black pigmentation, and a third level of yellow pigmentation such that a sign may be fabricated with the word “Caution” formed against a translucent yellow background.

Signs imparting safety messages are normally standardized with the color green. Therefore, the third level of another sign imparting a safety message could be fabricated with the third level pigmented green with the words “Safety” highlighted thereby formed by levels 1 and levels 2 fabricated in white pigment and black pigment respectively. The normal standard for a “Warning” notice is an orange background and such a sign could similarly be fabricated.

Signs in industry imparting a message or notice without a warning, caution or danger, normally appear with blue pigmentation. Therefore the third level of the sign of the present invention could be fabricated with a third level pigmented blue and be of a translucent nature so as to highlight the word “Notice” formed thereon by the first level and second level.

After forming the text message on the sign, the sign can be prepared for securing to the appropriate location by forming a plurality of apertures 26 in its corners and using an appropriate fastener dependent upon the surface to which the sign is to be secured. Still further, while the sign of the present invention has been illustrated with respect to a planner orientation, signs may be fabricated such that they may be bent to an arcuate shape to confirm to the diameter of a wooden utility pole.

The method of manufacture of the sign material 10 of the present invention requires the use of a sheet extrusion die. A sheet extruder in which white, black and red pellets were fed through the extruder by means of their respective hoppers such that three levels would be extruded simultaneously, white, black and red, is possible, but extremely expensive as a result of controlling the temperature and viscosity across the face of the sheet dye. Applicant accomplishes the fabrication process using an extruder in which two of the levels are extruded and immediately bonded with the third level. FIG. 4 is illustrative of this process.

An extruder 40 is fed black pigmented pellets of high density polyethylene 42 from hopper 44 and red pellets of high density polyethylene 46 from hopper 48. These pellets become molten and are extruded from sheet die 50 in a sheet of the desired width and thickness of each level in molten form. Upon exiting the sheet die 50, the second level 14 is immediately brought into contact with a solid white pigmented level 12 from a takeoff roll 52, and the solid white level 12 and the molten second level, black pigment 14 and third level red pigment 16 pass through adjustable high compression rollers 54 and 56, which bonds or fuses the first level white pigment 12, the second level black pigment 14 and the third level, red pigment 16. Sign material 10 thus formed is subjected to a cooling process to complete the bonding after which the signed material is wound up in a take up roll for storage or for further fabrication into a tri-colored, three level, three dimensional sign as heretofore discussed.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

1. A multi layer sign material from which a sign is fabricated, said multi layer sign material comprising a first layer of high density, UV stabilized polyethylene; a second layer of high density, UV stabilized polyethylene, and a third layer of high density, UV stabilized polyethylene, said first, second and third layers being bonded together, each of said layers having a separate, distinct pigmented color, said sign material being cut to the desired shape of a sign, and a message imparted onto said sign by selectively removing portions of said first layer or said second layer.

2. The sign material in accordance with claim 1 wherein said first layer is formed with a thickness preferably of 0.020 inches.

3. The sign material in accordance with claim 1 wherein said second layer is formed with a thickness of preferably 0.035 inches.

4. The sign material in accordance with claim 1 wherein said third layer is formed with a thickness sufficient to provide stability to said sign dependent upon said sign's size.

5. The sign material in accordance with claim 1 wherein said selected removal of portions of said first layer and second layer is accomplished by routing, engraving, abrading, or other suitable means, in order to impart a desired message on said sign.

6. The sign material in accordance with claim 1 wherein said first layer of said sign material is pigmented white.

7. The sign material in accordance with claim 1 wherein said second layer of said sign material is pigmented black.

8. The sign material in accordance with claim 1 wherein said third layer of said sign material is pigmented so as to be translucent to natural or artificial light, thereby enhancing visibility.

9. The sign material in accordance with claim 8 wherein said third layer of said sign material is pigmented red, green, or yellow.

10. A method for the manufacture of a three layer sign material and the fabrication of a sign therefrom, said method comprising:
introducing pellets of high density, UV stabilized polyethylene of black pigmentation into a first hopper;
introducing pellets of high density, UV stabilized polyethylene being pigmented in a color translucent to natural or artificial light into a second hopper;
introducing said pellets into an extruder and melting said pellets;
extruding said molten high density polyethylene of translucent pigmentation onto a sheet die;
extruding said molten high density polyethylene of black pigmentation on top of said molten high density polyethylene of translucent pigmentation on said sheet die;
bringing said layers of molten high density polyethylene of translucent pigmentation and said layer of molten high density polyethylene of black pigmentation and registration with a take off roll, said take off roll having positioned thereon a layer of set, high density polypropylene of white pigmentation;
overlaying said layer of high density polypropylene of white pigmentation over said molten layer of high density polyethylene of black pigmentation;
subjecting said layers of high density polyethylene to a series of compression rollers for bonding and fusing said three layers of high density polyethylene;
cooling said three layers of high density polyethylene;
collecting said three bonded layers of high density polyethylene on a take up roll;
cutting said sign material to the desired size and shape of a sign;
removing a selected portion of said layer of high density polyethylene of white pigmentation and a selected portion of said layer of high density polyethylene of said black pigmentation by means of abrading, routing, or engraving, in order to impart a text or indicia message to said sign.
